(19) United States
(12) Patent Application Publication
(10) Pub. No.: US 2014/0001149 A1
(43) Pub. Date: Jan. 2, 2014

(54) Crossed slit structure for nanopores

(71) Applicants: Jingwei Bai, Elmsford, NY (US); Stefan Harrer, Hampton (AU); Stanislav Polonsky, Putnam Valley, NY (US); Stephen M. Rossnagel, Pleasantville, NY (US)

(72) Inventors: Jingwei Bai, Elmsford, NY (US); Stefan Harrer, Hampton (AU); Stanislav Polonsky, Putnam Valley, NY (US); Stephen M. Rossnagel, Pleasantville, NY (US)

(73) Assignee: INTERNATIONAL BUSINESS MACHINES CORPORATION, Armonk, NY (US)

(21) Appl. No.: 13/536,915

(22) Filed: Jun. 28, 2012

(51) Int. Cl. B44C 1/22; H01B 13/00

(52) U.S. Cl. 216/17; 216/95

(57) ABSTRACT

For a cross slit structure that contains a nanopore, a layer is produced including a first spacer that penetrates through the layer. A subsequent layer over, and in direct contact with, the layer is also produced. The subsequent layer includes a second spacer penetrating through the subsequent layer. The first spacer and the second spacer are selectively etched away, creating a first slit and a second slit. Respective projections of these slits are crossing one another at an angle. At such a crossing an opening is formed which provides for fluid connectivity through the two layers.

### BACKGROUND

The present invention relates to nano-structures capable of molecular scale operations. In particular it relates to structures containing small openings, or nanopores.

### BRIEF SUMMARY

A layer is produced including a first spacer that penetrates through the layer. A subsequent layer over, and in direct contact with, the layer is also produced. The subsequent layer includes a second spacer penetrating through the subsequent layer. The first spacer and the second spacer are selectively etched away, creating a first slit and a second slit. Respective projections of these slits are crossing one another at an angle. At such a crossing an opening is formed which provides for fluid connectivity through the two layers.

### BRIEF DESCRIPTION OF THE SEVERAL VIEWS OF THE DRAWINGS

These and other features of the present invention will become apparent from the accompanying detailed description and drawings, wherein:

FIGS. 1A, 1B show schematic cross sectional views of a crossed slit structure according to an embodiment of the disclosure;

FIGS. 2A, 2B show schematic top views of a crossed slit structure according to an embodiment of the disclosure;

FIGS. 3A-3G show cross sectional views of a sequence of selected processing steps in the fabrication of a crossed slit structure according to an embodiment of the disclosure; and

FIGS. 4A-4C schematically depict top views a structure with a plurality of slits and multiple openings according to an embodiment of the disclosure.

### DETAILED DESCRIPTION

Small openings, often referred to as nanopores, find applications in a wide variety of endeavors in the fields of physics, biology, chemistry, and others. For example, nanopores may find uses for DNA sequencing. In order to distinguish individual molecules the size of the nanopore should be shrunk down to the sub-10 nm region. A process for reproducible production of nanopores with controlled sizes down to the nm regime would be useful for many applications.

Embodiments of the present invention teach structures with nanopores and their methods of fabrication. The nanopores may be fabricated individually, or in arrays containing a multitude of small openings, with pore sizes from sub nanometer to micrometer scales.

In a typical embodiment of the invention two small slits are created in two adjacent layers in a crossed geometric configuration. At the intersection of the projections of the two slits an opening is formed. Through the opened nanopore two reservoirs on opposing sides of the layers will be in fluid connectivity, meaning molecules that would fit through the nanopore would be able to pass.

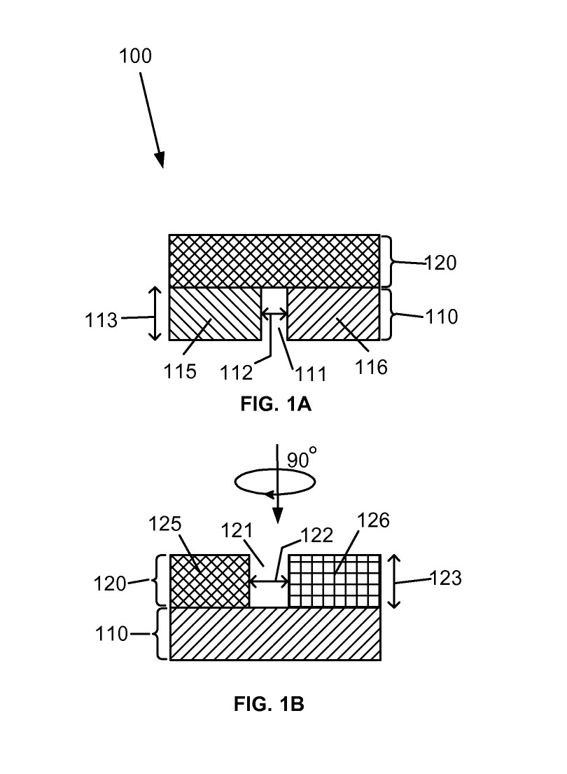

FIGS. 1A, 1B show schematic cross sectional views of a crossed slit structure 100 according to an embodiment of the disclosure. As FIGS. 1A and 1B show, the structure 100 for creating the small opening is made of two layers, a first layer 110, and a second layer 120. The second layer 120 is disposed over, and it is in direct contact with, the first layer 110.

The first layer 110 has a first thickness 113, and contains a first slit 111. The first slit 111 penetrates all the way through the first thickness 113, reaching to the second layer 120. Consequently, the first layer 110 is separated into a first 115 and a second 116 region by the first slit 111. The first slit has a width 112, which width is the distance separating the first 115 and the second 116 regions of the first layer 110.

The view of FIG. 1B, as indicated, is rotated by 90° around a vertical axis relative to the view of FIG. 1A. The term vertical is used to refer to a direction which is perpendicular to the plane of the first 110 and second 120 layers.

The second layer 120 has a second thickness 123, and contains a second slit 121. The second slit 121 penetrates all the way through the second thickness 123, reaching to the first layer 110. Consequently, the second layer 120 is separated into a first 125 and a second 126 region by the second slit 121. The second slit has a width 122, which width is the distance separating the first 125 and the second 126 regions of the second layer 120.

In FIG. 1A the second slit 121 is not visible because it is running in parallel with the plane of the cross sectional view. In FIG. 1B the first slit 111 is not visible because it is running in parallel with the plane of the cross sectional view. However, where the two slits run over/under each other a small opening, or nanopore, is formed, creating a pathway between the two opposing sides of the crossed slit structure 100.

Since both the first 110 and the second 120 layers, besides their respective slits, also contain two separated regions there are various possibilities for material choices in differing embodiments of the invention. The first 115 and second 116 regions of the first layer 110 may be composed of the same material, or they may be composed of differing materials. One, or both of the first 115 and second 116 region may be composed of electrically conductive, or electrically insulating materials. The same considerations apply to the first 125 and second 126 regions of the second layer 120, including that the two layers 110, 120, are composed of the same or of differing materials. Thus, in various representative embodiments of the disclosure the four differing regions may have all possible combinations of material composition in regarding sameness and electrical conductivity. Various choices maybe made in accordance of the intended use of the crossed slit structure 100.

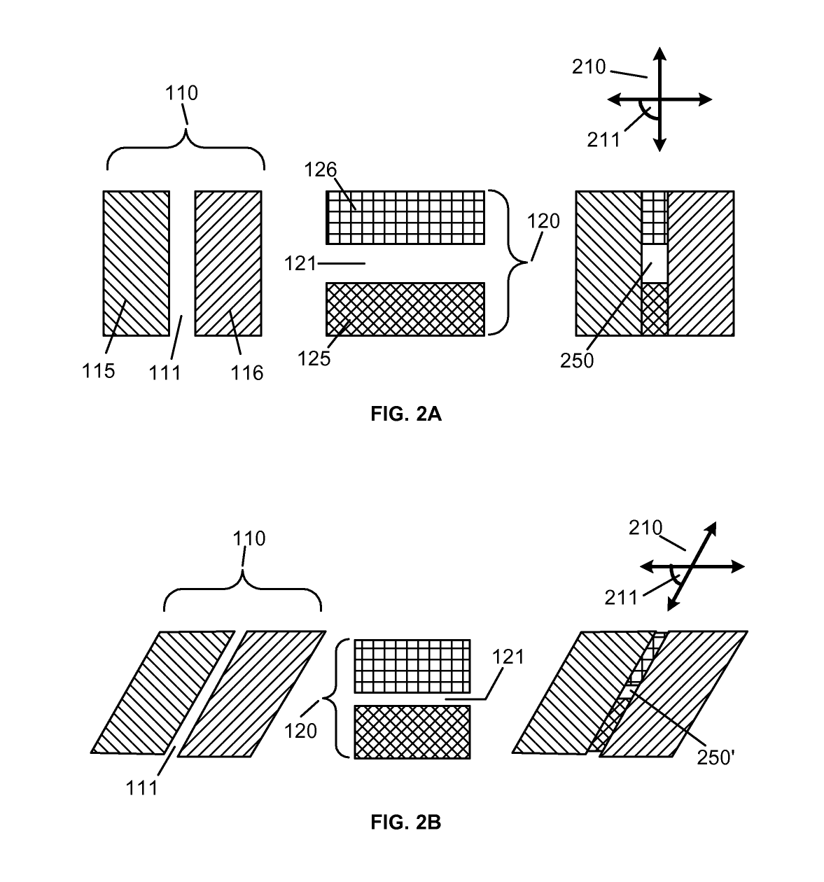

FIGS. 2A, 2B show schematic top views of a crossed slit structure according to an embodiment of the disclosure. FIG. 2A shows an embodiment where the two slits 111, 121 have been fabricated in the two layers 110, 120 with a 90° angle directionality relative to one another. Since the two slits are in two differing layers, the slits, as such, do not cross each other. However, the angle relation of the slits, and hence the character of the nanopore 250, may be described though a projection 210 of the slits. For instance, if the slits are projected vertically onto a plane parallel with the two layers 110, 120, the projections of the slits 210, indicated in the FIGS. 2A and 2B as line segments with double arrow endings, have a well defined crossing angle 211. FIG. 2B differs from FIG. 2A only that it shows a crossing angle that is different than 90°, resulting in an opening, or nanopore, shaped as a general parallelogram 250′, instead of a rectangle 250 as shown in FIG. 2A. Obviously, if the two slits 111, 121 have the same width and the projections are crossing at 90°, the pore 250 would be square shaped. In embodiments of the present

invention the crossing angle 211 for characterizing the two projections 210 is defined as an angle in 0° to 90° domain. In representative embodiments of the instant disclosure the crossing angle 211 may be between in 20° and 90°. It is also obvious that for all cases the length of the sides of nanopores 250 250′ equal the widths of the respective slits 112 122.

Since selecting the direction of the slits and carrying out the fabrication of the slits 111, 121 is part of producing of the layers, the angle between the crossing of the projections 211 depends on the manner of producing the first layer 110 and the second layer 120. In general, the slits are not necessarily following straight lines. One may fabricate layers with slits of various curvatures. For instance, the slits may be curved or circles of various sizes. Whatever the directional shapes of the slits may be, the crossing of the projections 210 at the site of any of the openings 250 is defined with the crossing angle 211.

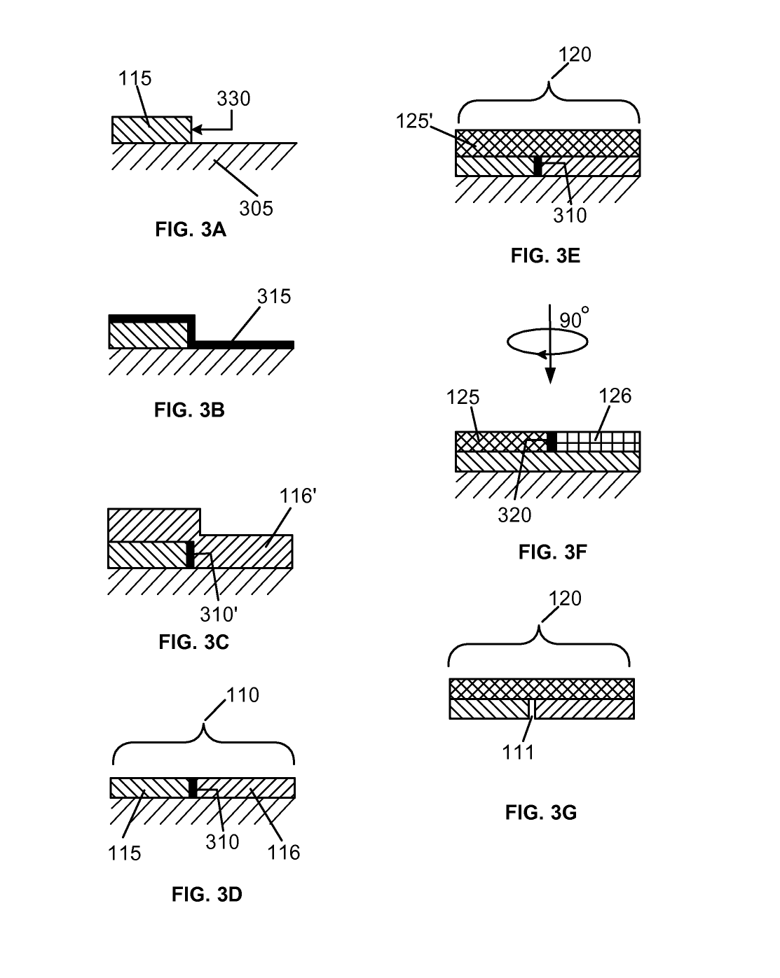

FIGS. 3A-3G show cross sectional views of a sequence of selected processing steps in the fabrication of a crossed slit structure according to an embodiment of the disclosure.

The general approach of fabricating a nanopore in the embodiments of the present invention is to create slits using a sidewall technique followed by chemical mechanical polishing (CMP). Such techniques are known in the arts, in particular in the semiconductor manufacturing arts. Hence, here only the salient features of fabricating the crossed slit structures will be presented.

A sidewall technique, also referred to as sidewall image transfer, which typically is capable of producing features smaller than lithography, is based on conformal deposition of a film, or layer, over a step, or ledge, followed by directional etching of the film. FIG. 3A shows an initial stage of the crossed slit structure processing. A film has been deposited, or disposed, over a substrate 305, and patterned, thus having a sidewall 330. The leftover part of this deposited film is, or will become, the first region of 115 of the first layer 110. Next, FIG. 3B, a film 315, or layer, is blanket disposed—that is without patterning—in a conformal manner over the first region 115 and the substrate 305. This conformal film 315 is then directionally etched, typically from the vertical direction. Due to the directionality of the etch only that part of the film 315 remains which covered the sidewall 330 of the first region 115 of the first layer 110. FIG. 3C shows a follow up stage, where a further layer 116′ is blanket deposited onto the structure, covering among others the remaining part 310′ of the directionally etched film 315, on the sidewall 330 of the first region 115 of the first layer 110. The presently deposited layer is indicated as 116′ because part of this layer will end up as the second region 116 of the first layer 110.

The structure, as schematically shown in FIG. 3C, is now being polished, or in more complete nomenclature, exposed to chemical mechanical polishing (CMP), as known in the art. CMP is thinning down and planarizes all films present on the surface. The state after CMP is shown in FIG. 3D, which is the stage where the fabrication of the first layer 110 is essentially completed, except for not as yet having a slit. The first layer 110 at this stage contains the first 115 and the second 116 regions. The first layer 110 also contains what is left of the sidewall covering layer 310′ of FIG. 3C, which will referred to as “spacer”. The first spacer 310 is located between the two regions 115 116 of the first layer. The spacer 310 is the same structure as the sidewall covering layer 310′, with the exception that due to the CMP the spacer 310 typically is smaller in the vertical direction, matching the essentially equal thicknesses of the two regions 115 116 of the first layer.

FIG. 3E shows an initial stage in producing the second layer 120. The second layer fabrication commences by disposing a layer 125′ over and in direct contact with the first layer 110. The presently deposited layer is indicated as 125′ because part of this layer will end up as the first region 125 of the second layer 120.

Producing the second layer 120 follows essentially the same processing path as the one that lead to the first layer 110. Again, a sidewall technique and CMP are used to produce the first 125 and second 126 regions of the second layer 120, with a second spacer 320 separating the two regions. This is the stage shown in FIG. 3F. This figure, FIG. 3F, as indicated, is rotated by 90° compared to the other figures in the FIG. 3 series, thus the cross sectional view of the second spacer 320 becomes visible.

In the following steps, the first spacer 310 and the second spacer 320 are being selectively etched away. After such selective etching a first slit 111 and a second slit 121 are created in the respective places of the first spacer 310 and of the second spacer 320. Following the state of processing as shown in FIG. 3F, the substrate 305 is also selectively etched away. The selective etching away of the two spacers and of the substrate, depending on choices of materials and/or geometrical parameters, may include one or more actual steps. The resulting structure is shown in FIG. 3G, which is essentially the same as that of FIG. 1A.

It is understood that all the figures are schematic and show only the nanopore structures. There obviously are structures for giving mechanical strength and support to the shown layers. For instance, the substrate 305 may not be etched away around the depicted layers, thus, supporting them as a frame. However such a frame type support by a substrate is only one possibility, and no limitation should be read into it. Any and all schemes for supporting the crossed slit structure 100 are within the scope of the embodiments of the instant invention.

The processing sequence as depicted in FIGS. 3A-3G, produced slits projections that are crossing at a 90° angle. Again, this should not be interpreted in limiting fashion. It is clear that the angle of the slits is determined by the relative direction the sidewalls that are produced in the first and the second layers. Thus, the angle of the slit projections 211 depends on the manner in which the first layer 110 and the second layer 120 are being produced.

The aspect ratios of the slits may span a rather wide range of values. For both the first slit 111 and the second slit 121 the height to width 112 122 ratio may be between 1:1 and 100:1. The height of the slits is the same as the layer thicknesses 113 123. The lower limit of height to width ratio of 1:1 derives from the nature of the sidewall technique. The height of the sidewall 330 which is related to the slit height, should not be much less than the thickness of the conformally deposited film 315, which is related to the slit width. The upper limit of height to width ratio of 100:1 is related to the effectiveness of the selective etching process which removes the spacers.

The absolute value of a slit width may be as small as sub 1 nm. The width depends on the amount of material coverage of the conformal layers on the sidewalls, which may be as little as a few atomic layers. At the same time layer thicknesses may be scaled up to micrometer dimensions, as well. Consequently, the presented fabrication techniques are capable of producing nanopore openings with sides from sub 1 nm to over 1 μm.

A wide range of materials may be selected for the various layers in accordance of the intended use of the crossed slit structure 100. Constrains exist, however, in that etching methods should exist for the various differential etchings needed in the described processes. For instance, all the sections of both layers may be of silicon nitride (Si₃N₄), while the spacers may be fabricated of silicon dioxide (SiO₂) or aluminum oxide (Al₂O₃). Electrically conductive materials that are suitable for the layers, without intent of limiting, may include Au, Pt, W, Ni, Cu, TaN, TiN. For instance, when using TiN/Al₂O₃ metal/spacer combination, NH₄OH may be use to selectively remove Al₂O₃. The substrate 305 material, for instance, may simply be silicon (Si), but others such as sapphire Al₂O₃, may also be considered.

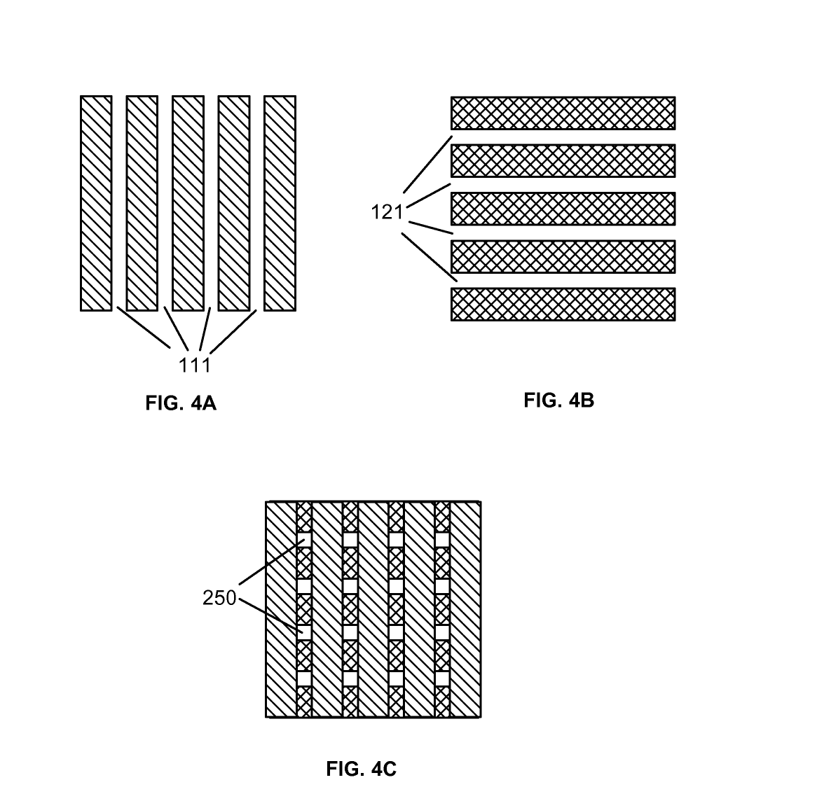

FIGS. 4A-4C schematically depict top views a structure with a plurality of slits and multiple openings according to an embodiment of the disclosure. Independently of one another, both the first layer 110, shown separately in FIG. 4A, or the second layer 120, shown separately in FIG. 4B, may be produced with a plurality of slits 111 121. One would simply pattern each layer where pluralities of slits are desired with a plurality of step sidewalls 330. Again, the projection of the slits may intersect at any angle, although the figures show 90° angles. As FIG. 4C indicates, with a plurality of slits on either layer one obtains multiple openings 250, or pores, in one or in both horizontal directions. The plurality of slits in either layer may be only 2, or may reach into the thousands. Accordingly, one may fabricate as desired, a multiple of only 2 openings, or a multiple of millions of openings.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

In addition, any specified material or any specified dimension of any structure described herein is by way of example only. Furthermore, as will be understood by those skilled in the art, the structures described herein may be made or used in the same way regardless of their position and orientation. Accordingly, it is to be understood that terms and phrases such as “under,” “upper”, “side,” “over”, “underneath”, “parallel”, “perpendicular”, “vertical”, etc., as used herein refer to relative location and orientation of various portions of the structures with respect to one another, and are not intended to suggest that any particular absolute orientation with respect to external objects is necessary or required.

The foregoing specification also describes processing steps. It is understood that the sequence of such steps may vary in different embodiments from the order that they were detailed in the foregoing specification. Consequently, the ordering of processing steps in the claims, unless specifically stated, for instance, by such adjectives as “before”, “ensuing”, “after”, etc., does not imply or necessitate a fixed order of step sequence.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature, or element, of any or all the claims.

Many modifications and variations of the present invention are possible in light of the above teachings, and could be apparent for those skilled in the art. The scope of the invention is defined by the appended claims.

1. A method, comprising:
producing a first layer having a first thickness, wherein said first layer comprises a first spacer penetrating through said first thickness, wherein said first spacer was fabricated using a sidewall image transfer technique, and said first spacer has a first width of between about 0.5 nm and 10 nm;
producing a second layer over and in direct contact with said first layer, wherein said first layer and said second layer are having a common interface, said second layer having a second thickness and comprises a second spacer penetrating through said second thickness, wherein said second spacer was fabricated using said sidewall image transfer technique, and said second spacer has a second width of between about 0.5 nm and 10 nm; and
selectively etching away said first spacer and said second spacer, wherein creating a first slit and a second slit in the respective places of said first spacer and said second spacer, wherein respective projections of said first slit and said second slit are crossing one another at an angle creating an opening through said common interface, wherein said opening has zero length.

2. The method of claim 1, wherein said angle is between 20° and 90°.

3. The method of claim 1, wherein said method further comprises:
producing said first layer with a plurality of said first slit, wherein creating multiple ones of said opening.

4. The method of claim 1, wherein said method further comprises:
producing said second layer with a plurality of said second slit, wherein creating multiple ones of said opening.

5. (canceled)

6. The method of claim 1, wherein said first layer is separated into a first and a second region by said first slit, and wherein said first and said second region of said first layer are composed of the same material.

7. The method of claim 6, wherein one or both of said first and said second region of said first layer are composed of electrically conductive materials.

8. (canceled)

9. The method of claim 1, wherein said second layer is separated into a first and a second region by said second slit, and wherein said first and said second region of said second layer are composed of the same material.

10. The method of claim 9, wherein one or both of said first and said second region of said second layer are composed of electrically conductive materials.

11. The method of claim 1, wherein said first spacer and said second spacer are composed of the same material.

12. (canceled)
